(19) United States
(12) Patent Application Publication
(10) Pub. No.: US 2018/0212310 A1
(43) Pub. Date: Jul. 26, 2018

(54) MOBILE DEVICE

(71) Applicant: Quanta Computer Inc., Taoyuan City (TW)

(72) Inventors: Chin-Lung TSAI, Taoyuan City (TW); Chung-Ting HUNG, Taoyuan City (TW); Ying-Cong DENG, Taoyuan City (TW); Kuan-Hsien LEE, Taoyuan City (TW); Chung-Hung LO, Taoyuan City (TW); Ching-Hai CHIANG, Taoyuan City (TW); Yi-Ling TSENG, Taoyuan City (TW)

(21) Appl. No.: 15/604,901

(22) Filed: May 25, 2017

(30) Foreign Application Priority Data
Jan. 23, 2017 (TW) 106102373

(51) Int. Cl. H01Q 1/24; H01Q 9/26; H01Q 1/38; H01Q 5/30

(52) U.S. Cl. CPC H01Q 1/242; H01Q 5/30; H01Q 1/38; H01Q 9/26

(57) ABSTRACT

A mobile device includes an antenna element, a first sensing metal element, a second sensing metal element, and a metal connection line. The antenna structure can cover an operation frequency band. The metal connection line is connected between the first sensing metal element and the second sensing metal element. The metal connection line has a resonant frequency which is not within the operation frequency band of the antenna element.

### CROSS REFERENCE TO RELATED APPLICATIONS

This Application claims priority of Taiwan Patent Application No. 106102373 filed on Jan. 23, 2017, the entirety of which is incorporated by reference herein.

### BACKGROUND OF THE INVENTION

### Field of the Invention

The disclosure generally relates to a mobile device, and specifically, to a mobile device for improving the performance of antenna radiation.

### Description of the Related Art

With the progress being made in mobile communication technology, mobile devices such as portable computers, mobile phones, tablet computers, multimedia players, and other hybrid functional mobile devices have become common. To satisfy the demands of users, mobile devices can usually perform wireless communication functions. Some functions cover a large wireless communication area; for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area; for example, mobile phones using Wi-Fi and Bluetooth systems and using frequency bands of 2.4 GHz, 5.2 GHz, and 5.8 GHz.

A conventional mobile device usually includes an antenna and a sensing pad, which are separate from each other, so as to support wireless communication and adjustment of radiation power. However, since there is limited space in a mobile device, the aforementioned antenna and sensing pad may be very close to each other, and this can lead to interference and poor radiation efficiency of the antenna. Accordingly, there is a need to design a novel mobile communication device for solving the problems of the prior art.

### BRIEF SUMMARY OF THE INVENTION

In a preferred embodiment, the disclosure is directed to a mobile device including an antenna element, a first sensing metal element, a second sensing metal element, and a metal connection line. The antenna structure covers an operation frequency band. The metal connection line is coupled between the first sensing metal element and the second sensing metal element. The metal connection line has a resonant frequency which is not within the operation frequency band of the antenna element.

In some embodiments, the metal connection line has a meandering structure.

In some embodiments, the total length of the metal connection line is substantially equal to 0.25 wavelength or 0.5 wavelength of the resonant frequency.

In some embodiments, the operation frequency band of the antenna element is a mobile communication frequency band.

In some embodiments, the antenna element is adjacent to the first sensing metal element, the second sensing metal element, and the metal connection line.

In some embodiments, the antenna element is disposed between the first sensing metal element and the second sensing metal element.

In some embodiments, a notch region is defined by the first sensing metal element, the second sensing metal element, and the metal connection line. The antenna element is positioned in the notch region.

In some embodiments, each of the first sensing metal element and the second sensing metal element substantially has a rectangular shape.

In some embodiments, the mobile device further includes an FPCB (Flexible Printed Circuit board). The metal connection line is disposed on the FPCB.

In some embodiments, the metal connection line includes one or more first traces, one or more second traces, and one or more via elements. The first traces are disposed on an upper surface of the FPCB. The second traces are disposed on a lower surface of the FPCB. The via elements are formed in the FPCB, and are coupled between the first traces and the second traces.

### BRIEF DESCRIPTION OF DRAWINGS

The invention can be more fully understood by reading the subsequent detailed description and examples with references made to the accompanying drawings, wherein:

FIG. 1 is a diagram of a mobile device according to an embodiment of the invention;

FIG. 2A is a diagram of VSWR (Voltage Standing Wave Ratio) when an antenna element is affected by a metal connection line;

FIG. 2B is a diagram of VSWR of an antenna element of a mobile device according to an embodiment of the invention;

FIG. 3 is a sectional view of a metal connection line 340 according to an embodiment of the invention;

FIG. 4 is a diagram of a mobile device according to an embodiment of the invention;

FIG. 5 is a diagram of a mobile device according to an embodiment of the invention; and

FIG. 6 is a diagram of a mobile device according to an embodiment of the invention.

### DETAILED DESCRIPTION OF THE INVENTION

In order to illustrate the purposes, features and advantages of the invention, the embodiments and figures of the invention are described in detail below.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

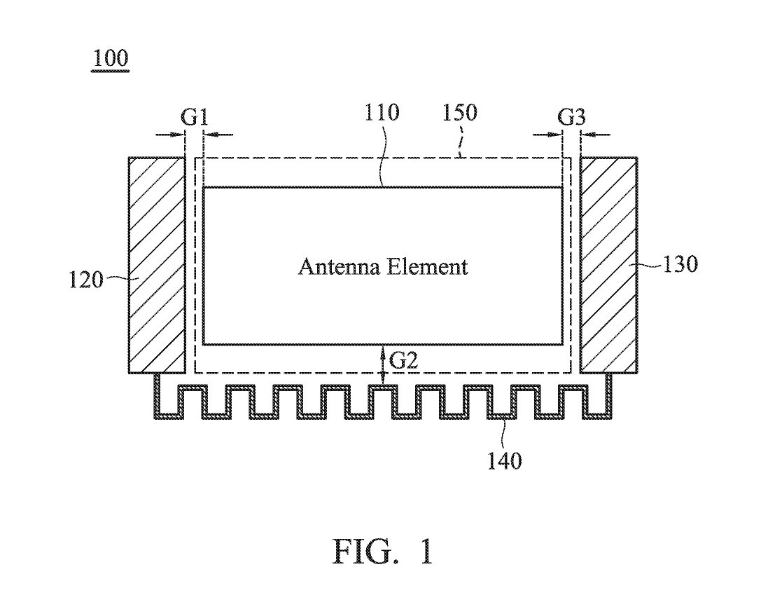

FIG. 1 is a diagram of a mobile device 100 according to an embodiment of the invention. The mobile device 100 may be a tablet computer, a notebook computer, or a smart watch. As shown in FIG. 1, the mobile device 100 includes an antenna element 110, a first sensing metal element 120, a second sensing metal element 130, and a metal connection line 140. It should be noted that the mobile device 100 may further include other components, such as a battery, a display device, a touch-control module, a speaker, and/or a housing, although they are not displayed in FIG. 1.

The type and shape of the antenna element 110 are not limited in the invention. For example, the antenna element 110 may be a monopole antenna, a dipole antenna, a loop antenna, a helical antenna, a patch antenna, or a chip antenna. In some embodiments, the antenna element 110 may include two or more sub-antenna elements, so as to form an antenna array.

The antenna element 110 is adjacent to the first sensing metal element 120, the second sensing metal element 130, and the metal connection line 140. For example, the antenna element 110 may be disposed between the first sensing metal element 120 and the second sensing metal element 130. Specifically, a notch region 150 may be defined by the first sensing metal element 120, the second sensing metal element 130, and the metal connection line 140. The notch region 150 may be substantially a rectangular clearance region. The antenna element 110 may be positioned in the notch region 150. The width of a first gap G1 between the antenna element 110 and the first sensing metal element 120 may be larger than at least 3 mm. The width of a second gap G2 between the antenna element 110 and the metal connection line 140 may be larger than at least 3 mm. The width of a third gap G3 between the antenna element 110 and the second sensing metal element 130 may be larger than at least 3 mm. The above gap sizes are arranged for reducing the undesired mutual coupling effect between each sensing element and the antenna element 110.

The first sensing metal element 120 and the second sensing metal element 130 are configured to detect an SAR (Specific Absorption Rate). For example, each of the first sensing metal element 120 and the second sensing metal element 130 may be substantially a rectangular metal plate or a square metal plate. When a human body (or a conductor) approaches the first sensing metal element 120 or the second sensing metal element 130, an effective capacitance is generated between the first sensing metal element 120 or the second sensing metal element 130 and the human body. At this time, the first sensing metal element 120 and the second sensing metal element 130 may generate a low-frequency signal, which includes the information of the aforementioned effective capacitance. The low-frequency signal may be transmitted further to a sensor chip coupled to the first sensing metal element 120 or the second sensing metal element 130 (not shown). The sensor chip can calculate the distance between the human body and the antenna element 110 by analyzing the low-frequency signal, so as to calculate the corresponding SAR. Then, the sensor chip may further fine-tune the output power of the antenna element 110 according to the corresponding SAR, so that the output power meets the requirements established by communication laws.

To reduce the manufacturing cost, the metal connection line 140 is coupled between the first sensing metal element 120 and the second sensing metal element 130, and therefore the first sensing metal element 120 and the second sensing metal element 130 can share a single sensor chip. That is, both the first sensing metal element 120 and the second sensing metal element 130 may be coupled through the metal connection line 140 to the same sensor chip (not shown). The antenna element 110 is configured to cover an operation frequency band, which may be a mobile communication frequency band, such as a LTE (Long Term Evolution) frequency band or a WLAN (Wireless Local Area Network) frequency band. In some embodiments, the metal connection line 140 has a meandering structure, and the total length of the metal connection line 140 is substantially equal to 0.25 wavelength or 0.5 wavelength (i.e., λ/4 or λ/2) of its resonant frequency (the total length of the metal connection line 140 may be measured when it stretches out and becomes a straight line). Preferably, the resonant frequency of the metal connection line 140 is not within the operation frequency band of the antenna element 110, so as to prevent the radiation performance of the antenna element 110 from being negatively affected.

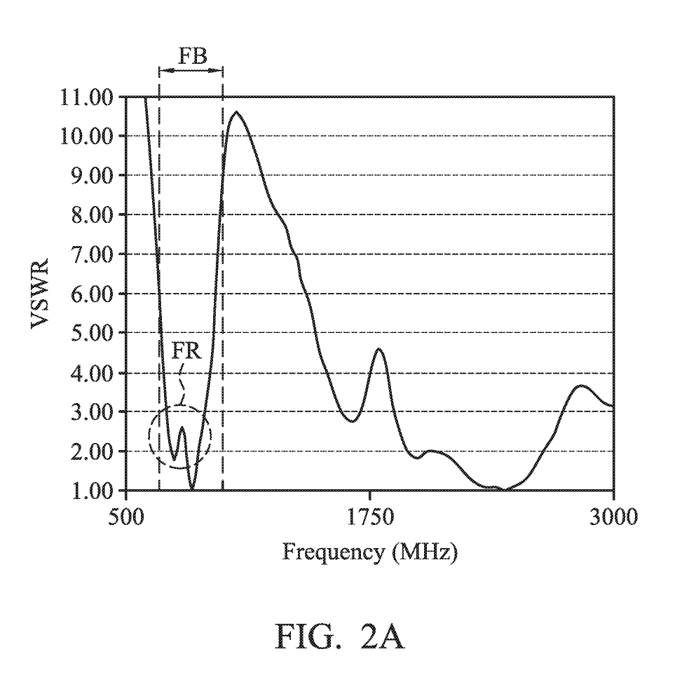

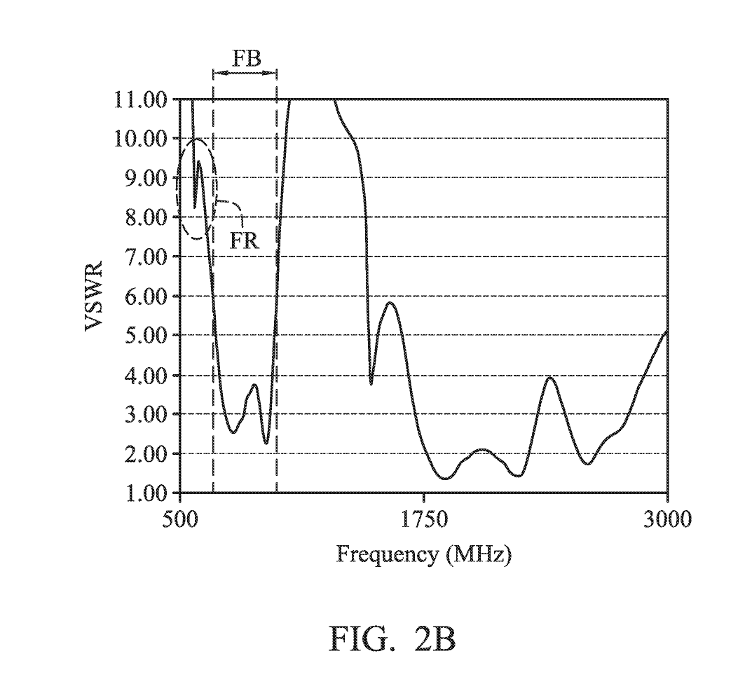

FIG. 2A is a diagram of VSWR (Voltage Standing Wave Ratio) when the antenna element 110 is affected by the metal connection line 140. The horizontal axis represents the operation frequency (MHz), and the vertical axis represents the VSWR. As shown in FIG. 2A, if the resonant frequency FR of the metal connection line 140 falls within the operation frequency band FB of the antenna element 110, it will be excited to generate an invalid resonant mode and interfere with the normal radiation pattern of the antenna element 110 (because the metal connection line 140 cannot generate the desired radiation). According to practical measurements, the gain of the antenna element 110 will decrease by 2.5 dBi.

FIG. 2B is a diagram of VSWR of the antenna element 110 of the mobile device 100 according to an embodiment of the invention. The horizontal axis represents the operation frequency (MHz), and the vertical axis represents the VSWR. As shown in FIG. 2B, with the proposed design of the invention, the resonant frequency FR of the metal connection line 140 is not within the operation frequency band FB of the antenna element 110 at all, so it will not interfere with the radiation performance of the antenna element 110. According to practical measurements, the gain of the antenna element 110 will increase by 2.5 dBi. In other words, if the metal connection line 140 and the antenna element 110 have different resonant frequencies, the existence of the metal connection line 140 almost does not negatively affect the antenna element 110.

Among the mobile device 100, the metal connection line 110 often extends adjacent to the antenna element 110. As a result, the length of the metal connection line 110 is approximately equal to the length of the antenna element 110, and their resonant modes tend to overlap with each other. The invention proposes a novel design, in which the resonant frequency of the metal connection line 140 is entirely different from the operation frequency band of the antenna element 110, and therefore the radiation gain of the antenna element 110 is effectively improved.

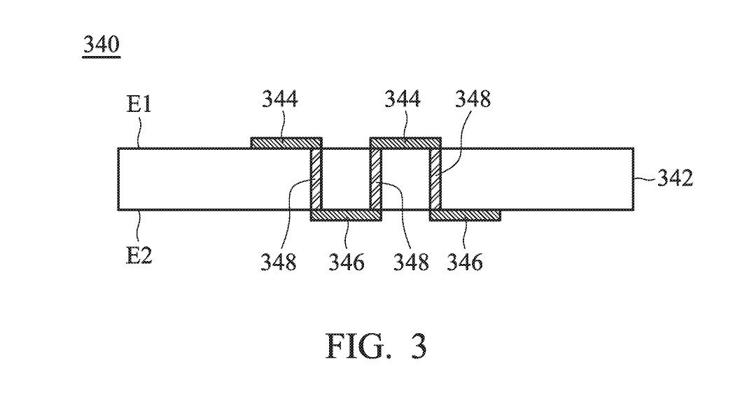

FIG. 3 is a sectional view of a metal connection line 340 according to an embodiment of the invention. The metal connection line 340 may be applied to the aforementioned mobile device 100. In the embodiment of FIG. 3, the mobile device 100 further includes an FPCB (Flexible Printed Circuit Board) 342, and the metal connection line 340 is disposed on the FPCB 342. The FPCB 342 has an upper surface E1 and a lower surface E2. The metal connection line 340 includes one or more first traces 344, one or more second traces 346, and one or more via elements 348. The first traces 344 are disposed on the upper surface E1 of the FPCB 342. The second traces 346 are disposed on the lower surface E2 of the FPCB 342. The via elements 348 are formed in the FPCB 342, and are coupled between the first traces 344 and the second traces 346. In other words, the metal connection line 340 may have a 3D (Three-Dimensional) meandering structure, and it is not limited to the planar meandering structure described in the above embodiments. It should be noted that the total number and the arrangement of the first traces 344, the second traces 346, and the via elements 348 are adjustable in response to different requirements, so as to provide the desired resonant lengths. The following embodiments will introduce, for example, a variety of configurations relative to the metal connection line 340.

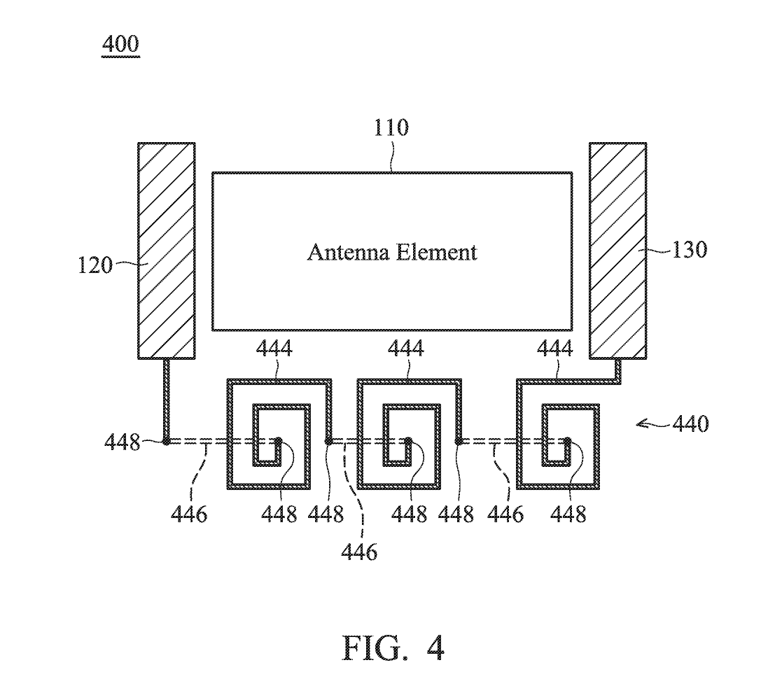

FIG. 4 is a diagram of a mobile device 400 according to an embodiment of the invention. FIG. 4 is similar to FIG. 1. In the embodiment of FIG. 4, a metal connection line 440 of the mobile device 400 includes multiple first traces 444, multiple second traces 446, and multiple via elements 448. Each of the first traces 444 may substantially have a spiral shape, and each of the second traces 446 may substantially have a straight-line shape, so as to form multiple spiral structures connected in series with each other. The resonant frequency of the metal connection line 440 is different from the operation frequency band of the antenna element 110. Other features of the mobile device 400 of FIG. 4 are similar to those of the mobile device 100 of FIG. 1. Accordingly, the two embodiments can achieve similar levels of performance.

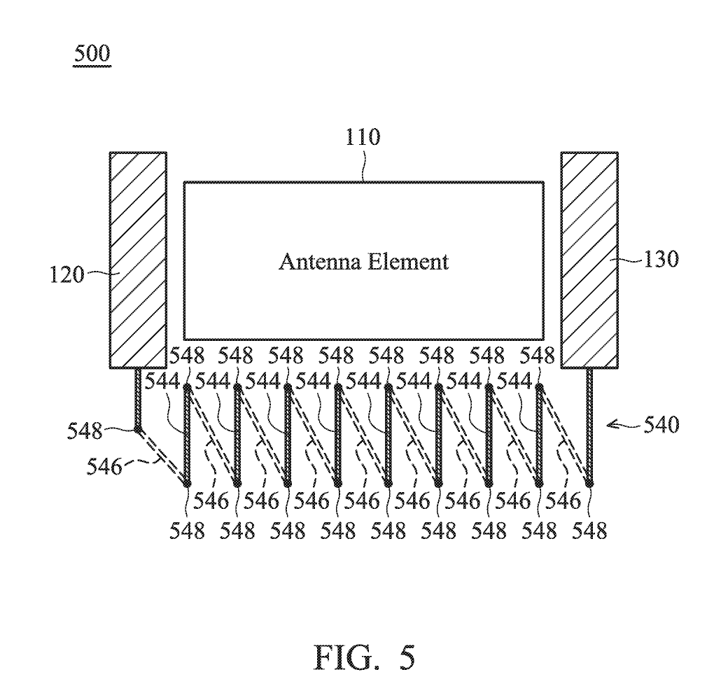

FIG. 5 is a diagram of a mobile device 500 according to an embodiment of the invention. FIG. 5 is similar to FIG. 1. In the embodiment of FIG. 5, a metal connection line 540 of the mobile device 500 includes multiple first traces 544, multiple second traces 546, and multiple via elements 548. Each of the first traces 544 may substantially have a straight-line shape, and each of the second traces 546 may also substantially have a straight-line shape. The first traces 544 and the second traces 546 are not parallel to each other (e.g., the angle between each first trace 544 and each second trace 546 is from 10 to 45 degrees), so as to form a sawtooth structure. The resonant frequency of the metal connection line 540 is different from the operation frequency band of the antenna element 110. Other features of the mobile device 500 of FIG. 5 are similar to those of the mobile device 100 of FIG. 1. Accordingly, the two embodiments can achieve similar levels of performance.

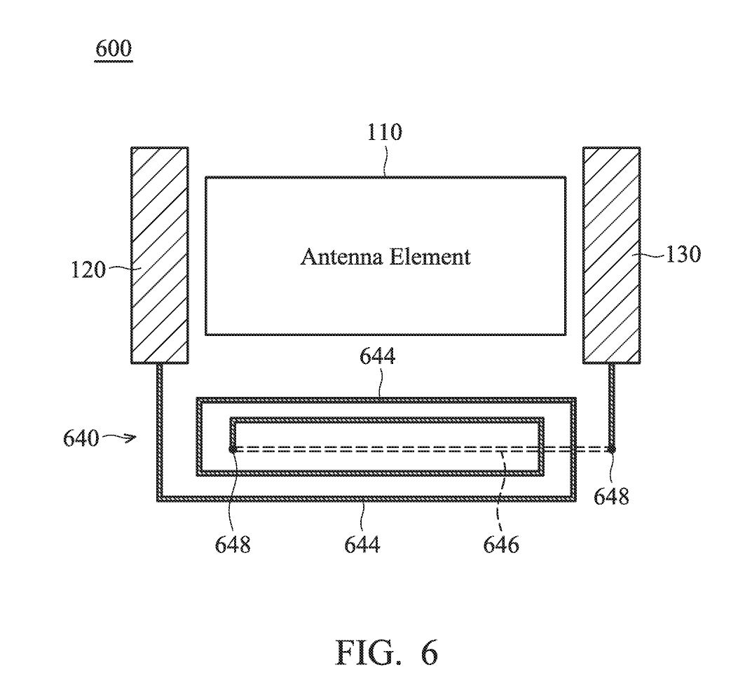

FIG. 6 is a diagram of a mobile device 600 according to an embodiment of the invention. FIG. 6 is similar to FIG. 1. In the embodiment of FIG. 6, a metal connection line 640 of the mobile device 600 includes a first traces 644, a second traces 646, and multiple via elements 648. The first trace 644 may substantially have a spiral shape, and the second trace 646 may substantially have a straight-line shape, so as to form a single spiral structure. The resonant frequency of the metal connection line 640 is different from the operation frequency band of the antenna element 110. Other features of the mobile device 600 of FIG. 6 are similar to those of the mobile device 100 of FIG. 1. Accordingly, the two embodiments can achieve similar levels of performance.

The invention proposes a novel mobile device. In comparison to the conventional design, the invention has at least the advantages of: (1) minimizing the size of the antenna element, (2) improving the radiation gain of the antenna element, (3) preventing the sensing metal element and the metal connection line from resonating with the antenna element, and (4) reducing the total manufacturing cost. Therefore, the invention is suitable for application in a variety of small-size mobile communication devices.

Note that the above element sizes, element shapes, and frequency ranges are not limitations of the invention. An antenna designer can adjust these settings or values according to different requirements. It should be understood that the mobile device of the invention is not limited to the configurations of FIGS. 1-6. The invention may merely include any one or more features of any one or more embodiments of FIGS. 1-6. In other words, not all of the features shown in the figures should be implemented in the mobile device of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A mobile device, comprising:
an antenna element, covering an operation frequency band;
a first sensing metal element;
a second sensing metal element; and
a metal connection line, coupled between the first sensing metal element and the second sensing metal element, wherein the metal connection line has a resonant frequency which is not within the operation frequency band of the antenna element.

2. The mobile device as claimed in claim 1, wherein the metal connection line has a meandering structure.

3. The mobile device as claimed in claim 1, wherein a total length of the metal connection line is substantially equal to 0.25 wavelength or 0.5 wavelength of the resonant frequency.

4. The mobile device as claimed in claim 1, wherein the operation frequency band of the antenna element is a mobile communication frequency band.

5. The mobile device as claimed in claim 1, wherein the antenna element is adjacent to the first sensing metal element, the second sensing metal element, and the metal connection line.

6. The mobile device as claimed in claim 1, wherein the antenna element is disposed between the first sensing metal element and the second sensing metal element.

7. The mobile device as claimed in claim 1, wherein a notch region is defined by the first sensing metal element, the second sensing metal element, and the metal connection line, and wherein the antenna element is positioned in the notch region.

8. The mobile device as claimed in claim 1, wherein each of the first sensing metal element and the second sensing metal element substantially has a rectangular shape.

9. The mobile device as claimed in claim 1, further comprising:
an FPCB (Flexible Printed Circuit board), wherein the metal connection line is disposed on the FPCB.

10. The mobile device as claimed in claim 9, wherein the metal connection line comprises one or more first traces, one or more second traces, and one or more via elements, wherein the first traces are disposed on an upper surface of the FPCB, wherein the second traces are disposed on a lower surface of the FPCB, and wherein the via elements are formed in the FPCB and are coupled between the first traces and the second traces.
